(19) United States
(12) Patent Application Publication
(10) Pub. No.: US 2013/0017089 A1
(43) Pub. Date: Jan. 17, 2013

(54) DOUBLE ROW TAPERED BEARING ASSEMBLY AND WIND TURBINE

(71) Applicant: Henrik Stiesdal, Odense C (DK)

(72) Inventor: Henrik Stiesdal, Odense C (DK)

(21) Appl. No.: 13/521,490

(22) PCT Filed: Jul. 14, 2011
(86) PCT No.: PCT/EP2011/062058

§ 371 Date: Jul. 11, 2012

(30) Foreign Application Priority Data
Nov. 22, 2010 (EP) 10192048.6

(51) Int. Cl. F16C 19/18; F03D 11/00; F16C 19/38

(52) U.S. Cl. 416/174; 384/447; 384/570; 384/502

(57) ABSTRACT

A double row tapered bearing assembly includes a first portion and a second portion. The first portion includes a first ring and a second ring. The first ring is connected with the second portion via at least one row of tapered rollers or balls. The second ring is also connected with the second portion via at least one row of tapered rollers or balls. The first ring and the second ring each includes at least one groove. The at least one groove in the first ring faces the at least one groove in the second ring to form a cavity. At least one member is placed in the cavity.

### CROSS REFERENCE TO RELATED APPLICATIONS

This application is the US National Stage of International Application No. PCT/EP2011/062058, filed Jul. 14, 2011 and claims the benefit thereof. The International Application claims the benefits of European application No. 10192048.6 EP, filed Nov. 22, 2010. All of the applications are incorporated by reference herein in their entirety.

### FIELD OF INVENTION

The present invention relates to a double row tapered bearing assembly and to a wind turbine.

### BACKGROUND OF INVENTION

During extreme loading on the wind turbine rotor there is a risk that the internal bearing forces will cause the two inner rings of a double row tapered bearing to slide relative to each other. This is often referred to as cone shifting. When the load is reduced the two inner rings will then end up in a position of relative out of roundness. This geometric deviation will increase the hertzian stress level in the contact area between roller and raceway, which will increase the probability of bearing failure.

### SUMMARY OF INVENTION

This difficulty can be solved by shrink fitting a reinforcement tube inside the two inner rings. A difficulty with this solution is that it relies on high accuracy of the diameter of the shrink fitted tube. Moreover, it makes disassembly very difficult. Another possibility is to have a T- or I-shaped ring between the two inner rings. A basic difficulty with this solution is that it relies on high accuracy of the diameter of the rings to ensure that it fits properly.

It is a first objective of the present invention to provide a double row tapered bearing assembly which reduces cone shifting in a cost effective and easy way. It is a second objective of the present invention to provide an advantageous wind turbine.

The above objectives are achieved by the features of the independent claims.

The inventive double row tapered bearing assembly comprises a first portion and a second portion. The first portion comprises a first ring and a second ring. The first ring is connected with the second portion by means of at least one row of tapered rollers or at least one row of balls. The second ring is connected with the second portion by means of at least one row of tapered rollers or at least one row of balls.

The first ring and the second ring each comprise at least one groove. The at least one groove in the first ring faces the at least one groove in the second ring. The at least one groove of the first ring and the facing at least one groove in the second ring from a cavity. At least one member is placed in the cavity. By placing at least one member in the cavity formed by grooves of the first ring and the second ring a sliding of the rings in radial direction is avoided. This means that cone shifting is avoided as the member in the grooves of the bearing keeps the first ring and the second ring together in case of radial movement and/or radial forces acting on the bearing. Moreover, the invention is simpler than prior art solutions and easier to produce with larger tolerances. Moreover, the risk of fretting corrosion is low by having small areas of line contact under high surface pressure.

The inventive bearing may comprise a rotation axis. The first portion may be located radially inside of the second portion or the second portion may be located radially inside of a first portion.

Preferably the groove may have a rectangular or a tapered or an at least partly circular or an at least partly ellipsoid or an at least partly hypoellipsoid or an at least partly hyperellipsoid cross section. For example, the groove may have a half ellipsoid cross section.

The at least one member placed in the groove may have a rectangular or a tapered or an at least partly circular or an at least partly ellipsoid or an at least partly hypoellipsoid or an at least partly hyperellipsoid cross section. In this way the at least one member fits into the space in the grooves of the first and the second ring and sliding of the rings in radial direction is avoided.

Advantageously the at least one member placed in the groove comprises at least one segment, for instance a segment of a ring. This has the advantage, that the segments of the member can be easily placed in the groove. Moreover, a disassembly is very easy.

Preferably, the at least one groove and/or the at least one member placed in the groove comprise at least one positive slip angle. Providing the member, which preferably comprises a number of segmented rings, and/or the grooves in the first ring and the second ring of the bearing with one or more positive slip angles an easy assembly of a segmented ring or member into the grooves can be ensured.

Advantageously, the at least one member placed in the groove may have a cross sectional diameter of at least 5 mm, for example 8 mm. Furthermore, the at least one member placed in the groove may run all around the circumference of the groove except for a small gap to allow for tolerances. For example, the whole bearing may comprise a diameter size of e.g. 3000 mm or more and a width of e.g. 300 mm or more for a direct drive wind turbine. The wind turbine can be a 3 MW direct drive wind turbine.

The first ring and the second ring may comprise one or more grooves where a segmented ring shaped member can be placed in each groove. For example, the grooves may comprise preferably a cross section of somewhere between a half and one third or even less of an ellipsoid and/or hypoellipsoid and/or hyperellipsoid. This gives an open groove in which it is easy to fit a segmented ring shaped member.

Preferably, the at least one member placed in the groove may comprise or consist of at least one thread with a fracture elongation of at least 5%. Moreover, a bend double thread may be used. Advantageously the at least one member placed in the groove comprises brass and/or bronze and/or non-hardened steel and/or heat-treated steel.

For example, the segmented ring shaped member may comprise only one segment. The segment may be made by using a thread of brass or bronze or soft non-hardened steel or heat-treated steel or similar materials with a fracture elongation of 5% or more and with a cross sectional diameter of e.g. 8 mm. Alternatively a bend double thread maybe used giving a cross sectional diameter of e.g. 2×8 mm lying next to each other. The grooves in the first ring and the second ring, which may be radially inner rings, can than e.g. comprise a hypoellipsoid cross section e.g. with a=10, b=7.85 and n=1.7 using the Lamé-curve formula

$${\vert \frac{x}{a} \vert}^{n} + {\vert \frac{y}{b} \vert}^{n} = 1.$$

The member with for example a circular cross section may then be pressed into the two grooves in the inner rings giving a tight connection which may even be oil tight. In this way a further seal connection between the first ring and the second ring can be avoided.

The at least one member placed in the groove may comprise two sides with a different tapering angle. Moreover, the at least one member placed in the groove may comprise a side with a tapering angle which is less than the tapering angle of the side of the groove facing the side of the member. By using tapered grooves even larger tolerances can be used by the production of the grooves and the members.

For example, the rectangular segments of the member may comprise tapered end parts. Also here larger tolerances can be used by the production of the grooves and the segments of a member. For example, only one of the grooves may be tapered. Moreover, the members that are placed in the grooves may be tapered in one or both sides of the sides that fit into the grooves of the rings. This ensures a better fit to the grooves and larger tolerances can be used by the production of the members. Furthermore, one side or end of the members may comprise a different tapering angle than the other side or end of the member. The members may comprise a tapered angle that is less than a tapered angle of the grooves of the first ring and the second ring.

The at least one member may preferably comprise segments with an arc angle between 5° and 180°, advantageously between 10° and 20°. The segments of the segmented ring may preferably comprise an arc angle of 10 to 20 degrees giving respectively 18 to 36 segments. Also an arc angle of 5 to 10 degrees may be possible or even an arc angle of the segments of more than 20 degrees may be used though preferably not more than 180 degrees. What arc angle to choose depends on the actual size of the segmented ring due to transportation issues and due to the time it takes to install the chosen number of segments.

Moreover, the at least one member can comprise at least one plastic deformable area, for example at least one local plastic deformable area, and/or at least one protrusion, for example a plastic deformable protrusion. The at least one plastic deformable area and/or protrusion ensures that the member fits tightly to the grooves when the first ring and the second ring are pressed together by a given force. In this way larger tolerances can be used by the production of the members and the grooves.

The segments of the segmented ring-shaped member may comprise a material having a fracture elongation of more than 5%. This ensures that the segments are local deformable. This may even ensure an oil tight connection between the first ring and the second ring and the segments of the member when the first ring and the second ring and a segmented ring-shaped member in the grooves are pressed together with a certain force. By ensuring an oil tight connection directly at the grooves ensures a larger area with a large friction between the inner rings which counteracts the radial sliding movement of the inner rings in relation to each other.

The segmented ring-shaped member located inside the grooves of the first ring and the second ring of a bearing for avoiding cone shifting may also be used in other types of bearings having two or more rows of rollers, preferably tapered rollers, and/or balls and having two or more inner rings and one or more outer rings where one or more segmented rings are located inside the grooves of each pair of inner rings. If more than one outer ring is present one or more segmented rings may also be located inside the grooves of each pair of outer rings of the bearing.

The inventive wind turbine comprises a double tapered bearing assembly as previously described. The inventive wind turbine can comprise a generator with a rotor or a stator. The rotor or the stator may be supported by the inventive double tapered bearing assembly. Generally, the inventive wind turbine may be a gearless direct drive wind turbine. The inventive wind turbine has the same advantages as the previously described bearing assembly.

Further features, properties and advantages of the present invention will become clear from the following description of an embodiment in conjunction with the accompanying drawings. All described features are advantageous separate or in any combination with each other.

### BRIEF DESCRIPTION OF THE DRAWINGS

Elements corresponding to elements of previously described figures will be designated with the same reference numerals and will not be described again in detail.

FIG. 1 schematically shows part of a double tapered roller bearing in a sectional view.

FIG. 2 schematically shows a wind turbine.

FIG. 3 schematically shows a cross section of two grooves facing each other and a member placed in the groove.

FIG. 4 schematically shows part of an inventive double tapered roller bearing in a sectional view.

FIG. 5 schematically shows a variant of part of an inventive double tapered roller bearing in a sectional view.

FIG. 6 schematically shows a member for placing into a cavity in a sectional and perspective view.

FIG. 7 schematically shows a member for placing into a cavity in a sectional view.

FIG. 8 schematically shows a further variant of a member in a sectional view.

FIG. 9 schematically shows a further variant of a member in a sectional view.

FIG. 10 schematically shows another variant of a member in a sectional view.

FIG. 11 shows a ring segment is shown in a perspective and sectional view.

### DETAILED DESCRIPTION OF INVENTION

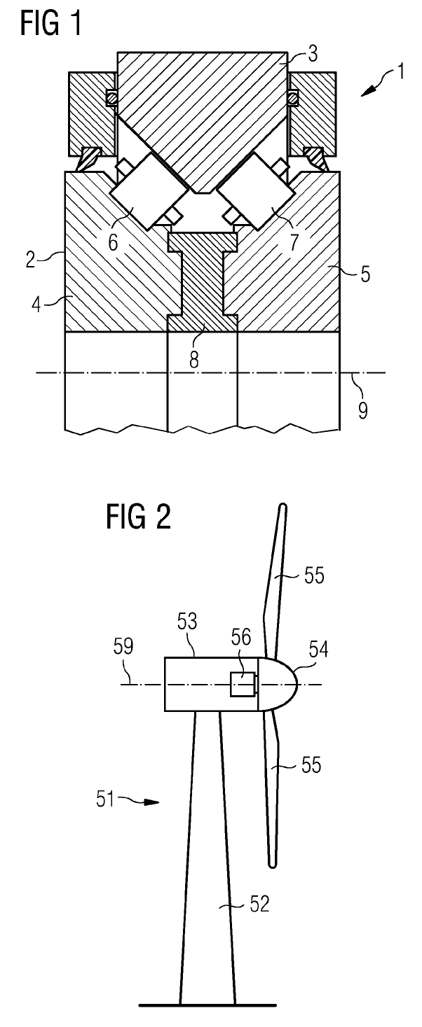

FIG. 1 schematically shows part of a known double tapered roller bearing 1 in a sectional view. The bearing 1 comprises a first portion 2 and a second portion 3. The first portion 2 comprises a first ring 4 and a second ring 5. Between the first ring 4 and the second portion 3 a first row of rollers 6 is located. Between the second ring 5 and the second portion 3 a second row of rollers 7 is located. The rotation axis of the bearing 1 is indicated by reference numeral 9.

Moreover, a spacer ring 8 is placed between the first ring 4 and the second ring 5. The spacer ring 8 has an I-shape with a number of protrusions to avoid a radial movement of the first ring 4 and the second ring 5 relatively to each other. To effectively avoid a radial movement the rings 4, 5 and 8 have a diameter of high accuracy.

FIG. 2 schematically shows a wind turbine 51. The wind turbine 51 comprises a tower 52, a nacelle 53 and a hub 54. The nacelle 53 is located on top of the tower 52. The hub 54 comprises a number of wind turbine blades 55. The hub 54 is mounted to the nacelle 53. Moreover, the hub 54 is pivot-mounted such that it is able to rotate about a rotation axis 59. A generator 56 is located inside the nacelle 53 or the generator may be attached to a structure part of the nacelle in such a way that it is located on one end part of the nacelle and further attached to a rotor hub. The wind turbine 51 is a direct drive wind turbine. The generator 56 comprises a rotor and a stator and an inventive double tapered bearing, as previously described, supporting the rotor or the stator.

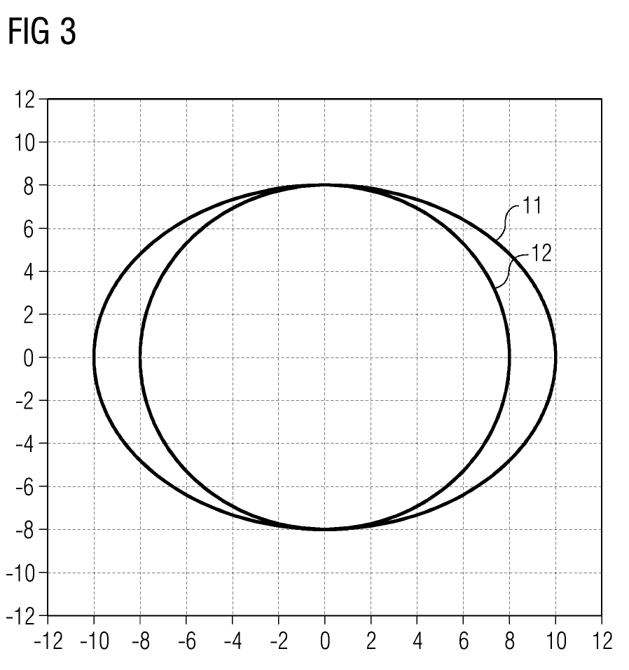

An embodiment of the present invention will now be described with reference to FIGS. 3 to 11. FIG. 3 schematically shows a cross section of two grooves facing each other and a member placed in the groove. Using the Lamé-curve formula

$${\vert \frac{x}{a} \vert}^{n} + {\vert \frac{y}{b} \vert}^{n} = 1.$$

The curve 11 is obtained by choosing the parameters a=10, b=7.85 and n=1.7. The obtained hypoellipsoid cross section 11 represents the cross section of the cavity which is formed by a groove in the first ring and a groove in the second ring facing each other. The curve 12, which has a circular shape, represents the cross section of a member placed in the groove. In FIG. 3 the member placed in the groove has a cross sectional diameter of 16 mm. Of course, other cross section diameters can be used.

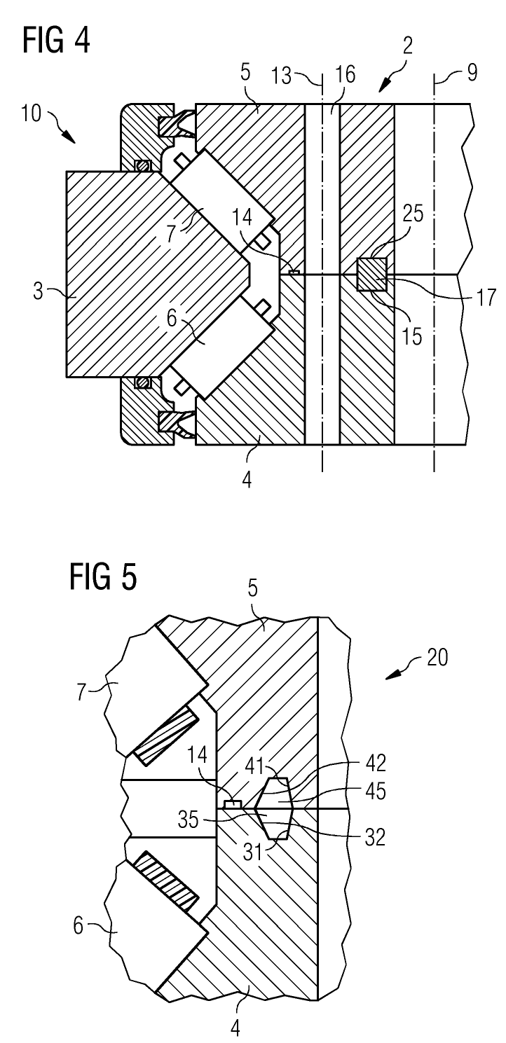

FIG. 4 schematically shows part of an inventive double tapered roller bearing in a sectional view. In FIG. 4 the first ring 4 comprises a first groove 15 and the second ring 5 comprises a second groove 25. Each groove 15 and 25 has a rectangular cross section. The grooves 15 and 25 are facing each other forming the cavity with a rectangular cross section. A member 17 with a corresponding rectangular cross section is placed in the cavity.

The first portion 2 comprises a hole 16 with a centre line 13 for fixation of the first ring 4 and the second ring 5 with each other. Moreover, a sealing means 14 is placed between the first ring 4 and the second ring 5 for providing a tight connection which may even be oil tight. In an alternative variant the sealing means 14 can be omitted.

FIG. 5 schematically shows a variant of part of an inventive double tapered roller bearing in a sectional view. In FIG. 5 the first ring 4 comprises a groove 35 with a first side 31 and a second side 32. The second ring 5 comprises a groove 45 with a first side 41 and a second side 42. The grooves 45 and 35 are facing each other. The first sides 31 and 41 are tapered in relating to the rotation axis 9. The second sides 32 and 42 are also tapered in relation to the rotation axis 9. The first sides 41 and 31 are tapered with a tapering angle which is less than the tapering angle of the second sides 32 and 42. The tapering angle is defined as the angle between the particular side 31, 32, 41, 42 with respect to the rotation axis 9.

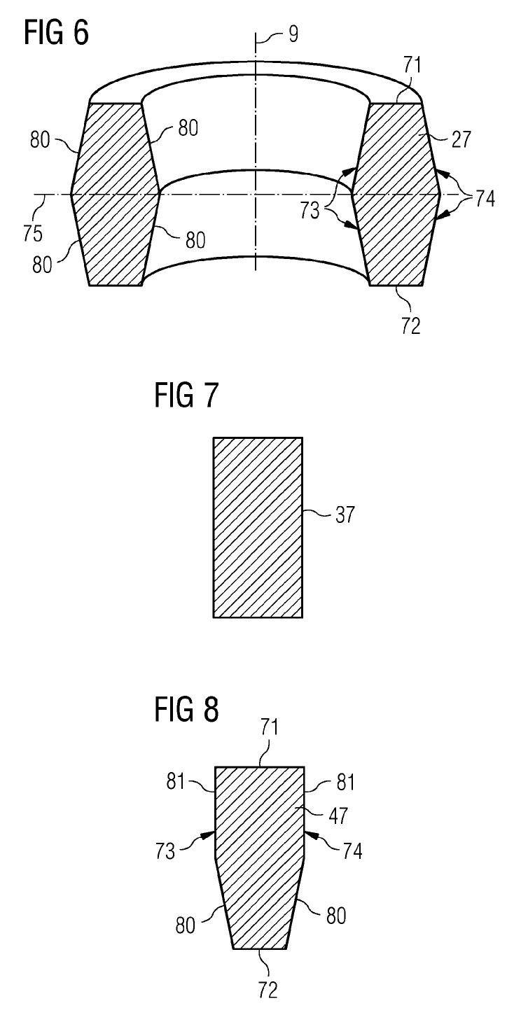

FIG. 6 schematically shows a member for placing into a cavity formed by the grooves between the first ring 4 and the second ring 5 in a sectional and perspective view. The member 27 shown in FIG. 6 has a shape of a section of a ring. Its cross section comprises a first end 71, a second end 72 and a first side 73 and a second side 74. The centre line perpendicular to the rotation axis 9 is indicated by reference numeral 75. The centre line 75 divides the first side 73 and the second side 74 into equal portions. The portions of the first side 73 and the second side 74 which adjoin to the first end 71 are tapered towards the first end 71. The portions of the first side 73 and the second side 74 which adjoin to the second end 72 are tapered towards the second end 72. Consequently the cross section of the member 27 has a double trapezoid shape.

In FIG. 6 the tapered portions 80 of the first side 73 are adjoining to each other. Also the tapered portions 80 of the second side 74 are adjoining each other.

FIG. 7 schematically shows a member for placing into a cavity formed by the grooves of the first ring and the second ring in a sectional view. The cross section of the member 37 shown in FIG. 7 has a rectangular shape.

FIG. 8 schematically shows a further variant of a member in a sectional view. The member 47 shown in FIG. 8 comprises a partly tapered first side 73 and a partly tapered second side 74. The first side 73 and the second side 74 are tapered towards the second end 72.

In FIG. 8 the first side 73 comprises a tapered portion 80 adjoining the second end 72 and adjoining a non-tapered portion 81 of the first side 73. Also the second side 74 comprises a tapered portion 80 which adjoins to the second end 72. The tapered portion 80 of the second side 74 adjoins a non-tapered portion 81 of the second side 74. The non-tapered portions 81 of the first side 73 and of the second side 74 are adjoining the first end 71.

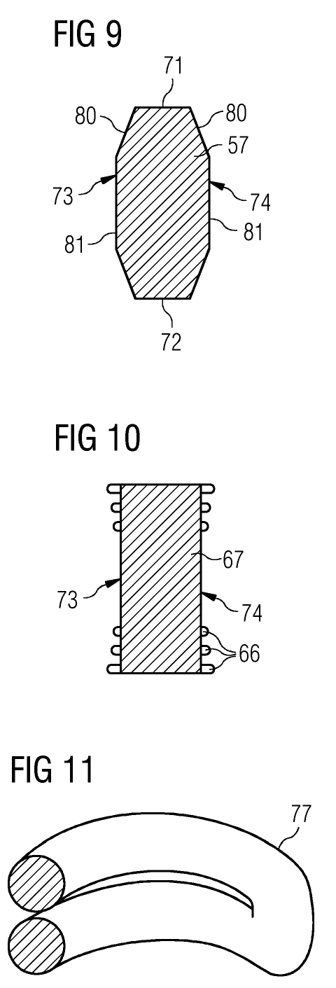

FIG. 9 schematically shows a further variant of a member in a sectional view. The member 57 shown in FIG. 9 comprises a first side 73 and a second side 74. Both sides 73 and 74 are partly tapered towards the first end 71 and partly tapered towards the second end 72. In FIG. 9 the first side 73 comprises a non-tapered area 81 in between a first tapered area 80 towards the first end 71 and a second tapered area 80 towards a second end 72. Accordingly the second side 74 comprises a non-tapered area 81 in between a first tapered area 80 towards the first end 71 and a second tapered 80 area towards the second end 72.

FIG. 10 schematically shows another variant of a member in a sectional view. The member 67 which is shown in FIG. 10 has a rectangular cross section. The first side 73 and the second side 74 each comprise a number of protrusions 66. The protrusions 66 may be plastic deformable giving a better fit between the grooves in the first ring 4 and the second ring 5 and the member 67.

In FIG. 11 a ring segment is shown in a perspective and sectional view. The member 77 in form of a bend ring segment has a circular cross section. It may have a cross sectional diameter of for example 8 mm. Instead of bending one ring segment as shown in FIG. 11 two ring segments or members with circular cross section may be joined together, for example by means like glue, welding or similar means.

Generally, the described members may comprise brass, bronze, soft non-hardened steel, heat-treated steel or a similar material with a fracture elongation of 5% or more.

### REFERENCE LISTING

1 double tapered roller bearing
2 first portion
3 second portion
4 first ring
5 second ring
6 first row of rollers
7 second row of rollers
8 spacer ring
9 rotation axis
10 double tapered roller bearing
11 cross section of the grooves
12 cross section of the member
13 centre line
14 sealing means
15 groove
16 hole for fixation
17 member
20 double tapered roller bearing
25 groove
27 member
31 first side
32 second side
35 groove
37 member
41 first side
42 second side
45 groove
47 member
51 wind turbine
52 tower
53 nacelle
54 hub
55 blade
56 generator
57 member
59 rotation axis
66 protrusions
67 member
71 first end
72 second end
73 first side
74 second side
75 centre line
77 member
80 tapered portion
81 non-tapered portion

1-15. (canceled)

16. A double row tapered bearing assembly, comprising:
a first portion comprising a first ring and a second ring, and
a second portion,
wherein the first ring is connected with the second portion via at least a first row of tapered rollers or balls,
wherein the second ring is connected with the second portion via at least a second row of tapered rollers or balls,
wherein the first ring and the second ring each comprise at least one groove, the at least one groove in the first ring facing the at least one groove in the second ring forming a cavity, and
wherein at least one member is placed in the cavity.

17. The double row tapered bearing assembly as claimed in claim 16, wherein each of the grooves has a rectangular or a tapered or a circular or an at least partly ellipsoid or an at least partly hypoellipsoid or an at least partly hyperellipsoid cross section.

18. The double row tapered bearing assembly as claimed in claim 16, wherein the at least one member comprises at least one segment of a ring.

19. The double row tapered bearing assembly as claimed in claim 16, wherein the at least one member has a rectangular or a tapered or a circular or an at least partly ellipsoid or an at least partly hypoellipsoid or an at least partly hyperellipsoid cross section.

20. The double row tapered bearing assembly as claimed in claim 16, wherein at least one of the grooves and/or the at least one member comprise at least one positive slip angle.

21. The double row tapered bearing assembly as claimed in claim 16, wherein the at least one member has a cross sectional diameter of at least 5 mm.

22. The double row tapered bearing assembly as claimed in claim 16, wherein the at least one member runs all around the circumference of the grooves except for a small gap to allow for tolerances.

23. The double row tapered bearing assembly as claimed in claim 16, wherein the at least one member comprises at least one thread with a fracture elongation of at least 5%.

24. The double row tapered bearing assembly as claimed in claim 16, the at least one member comprises brass and/or bronze and/or non-hardened steel and/or heat-treated steel.

25. The double row tapered bearing assembly as claimed in claim 16, wherein the at least one member comprises two sides with a different tapering angle.

26. The double row tapered bearing assembly as claimed in claim 16, wherein the at least one member comprises a side with a tapering angle which is less than the tapering angle of a side of one of the grooves that faces the side of the member.

27. The double row tapered bearing assembly as claimed in claim 16, wherein the at least one member comprises segments with an arc angle between 5 degrees and 180 degrees.

28. The double row tapered bearing assembly as claimed in claim 16, wherein the at least one member comprises segments with an arc angle between 10 degrees and 20 degrees.

29. The double row tapered bearing assembly as claimed in claim 16, wherein the at least one member comprises at least one plastic deformable area and/or at least one protrusion.

30. A wind turbine comprising a double row tapered bearing assembly according to claim 16.
